(19) United States
(12) Patent Application Publication
(10) Pub. No.: US 2007/0169846 A1
(43) Pub. Date: Jul. 26, 2007

(54) Edger

(75) Inventors: Rachel M. El-Hamamsy, Calgary (CA); Hussein Desouki, Calgary (CA); Sayed-Amr EI-Hamamsy, Calgary (CA)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(73) Assignee: Innovative Products for Life Inc., Calgary (CA)

(21) Appl. No.: 11/337,118

(22) Filed: Jan. 20, 2006

(51) Int. Cl. A01G 23/08

(52) U.S. Cl. 144/34.2

(57) ABSTRACT

An edger is formed by attaching a knife to a pole for edging a lawn. The edger may have a foot rest.

### BACKGROUND OF THE INVENTION

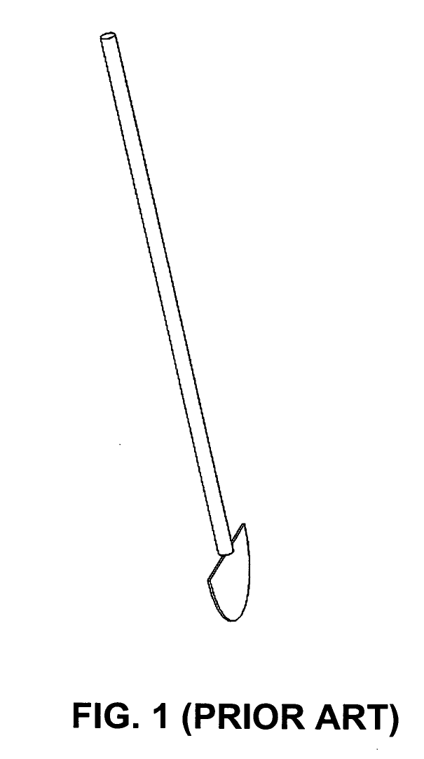

Various lawn edgers are known. A typical edger, known as a half-moon edger, is shown in FIG. 1, and has a broad, rounded cutting edge. The top of the half circle is folded over to provide a foot rest. The force is applied to the cutting edge by leaning on the pole and pressing down with the foot to make the cut. Then the edger is moved over and another cut is made. Because the half circle shape provides a large surface area contacting the lawn a substantial amount of force needs to be applied to it. The harder one presses down with the foot the more likely the edger is to lean than to cut through the ground.

Another type of edger is called #1 Lawn Edger TM or Step-n-Edge TM. This product improves over the half-moon edger by providing a modified foot rest. Force is applied by placing the foot in line with the cutting edge, rather than perpendicular to the cutting edge. However, the design still provides a very long cutting surface requiring more force than necessary and also a non-continuous action (i.e. the device cuts, is moved, then cuts again).

There are also many motor driven edgers which may or may not do a good job, but which would be expensive for the regular home owner to purchase and also require a certain skill to operate.

There is therefore a need for an edger that produces a clean, sharp edge to the lawn where the lawn meets a flower bed or a pathway. The edger should require a minimum of force to create the edge, should be easy to manipulate, and should be comfortable to use.

### SUMMARY OF THE INVENTION

An edger comprises a knife attached to a pole at an end of the pole. The edger may have a foot rest. These and other aspects of the invention are set out in the claims, which are incorporated here by reference.

### BRIEF DESCRIPTION OF THE FIGS.

Preferred embodiments of the invention will now be described with reference to the figures, in which like reference characters denote like elements, by way of example, and in which:

FIG. 1 is a front view of a conventional half-moon edger;

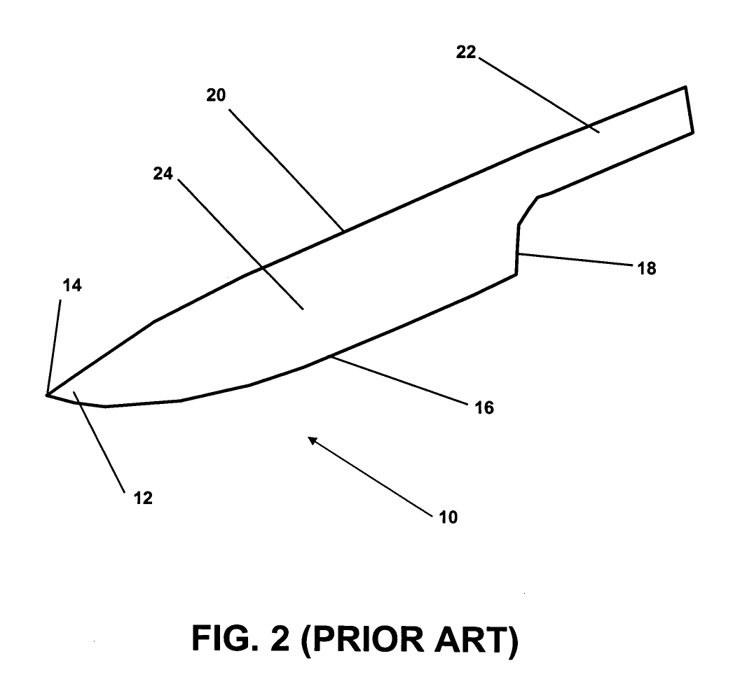

FIG. 2 is a side view of a conventional knife;

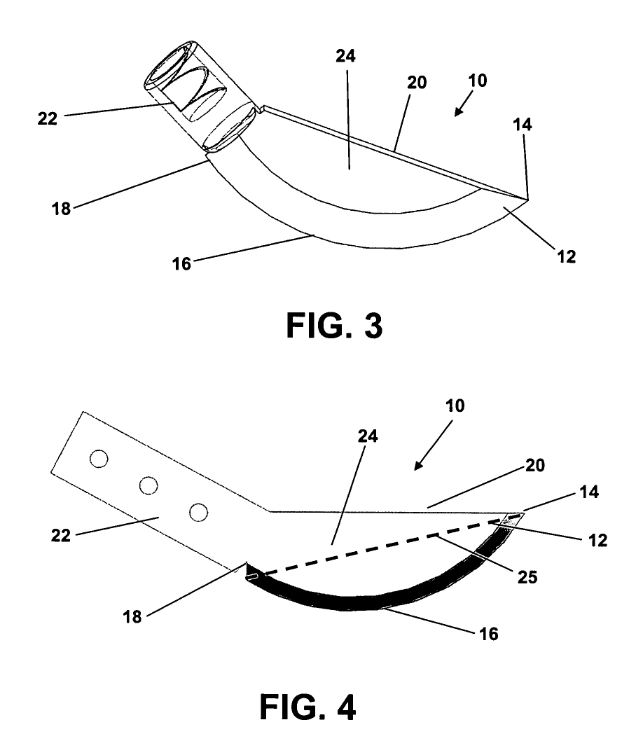

FIGS. 3 through 8 are perspective views of various embodiments of the knife;

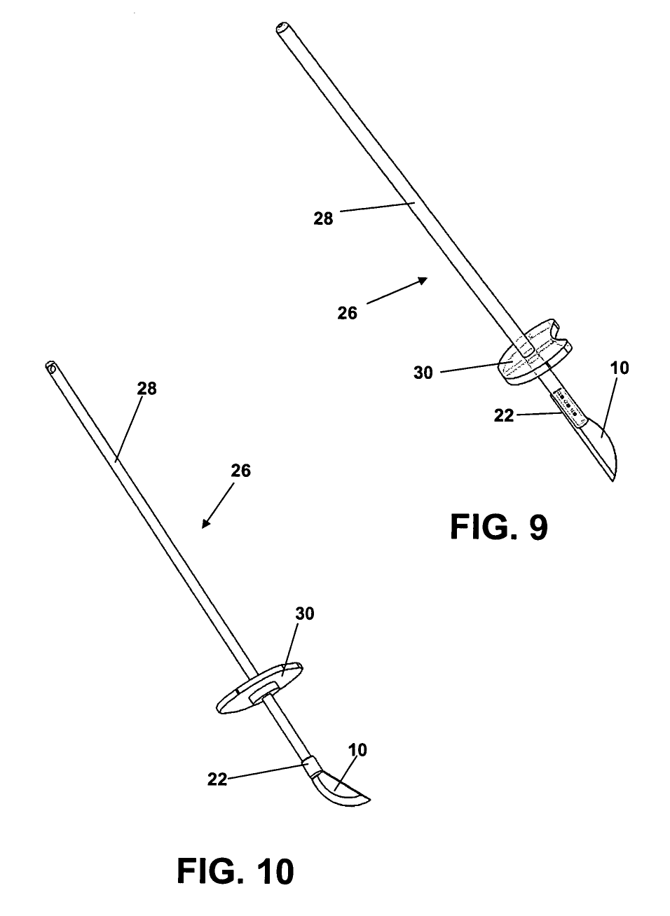

FIG. 9 is a perspective view of one embodiment of the edger;

FIG. 10 is a perspective view of another embodiment of the edger;

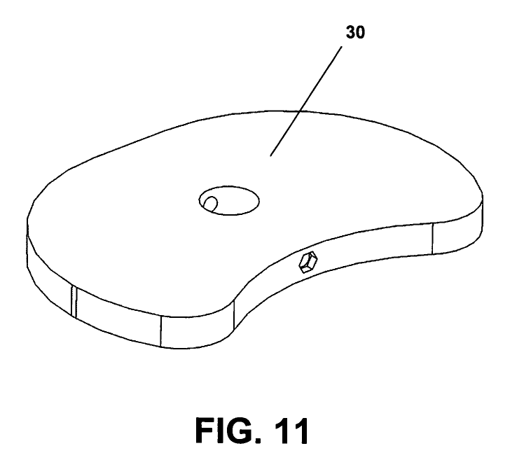

FIG. 11 is a perspective view of a foot rest; and

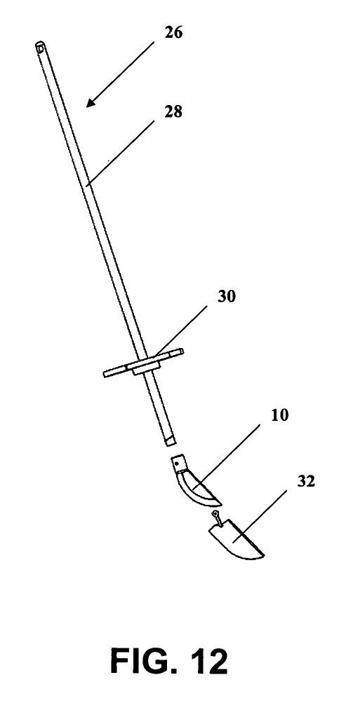

FIG. 12 is a perspective view of the edger with the knife and guard detached.

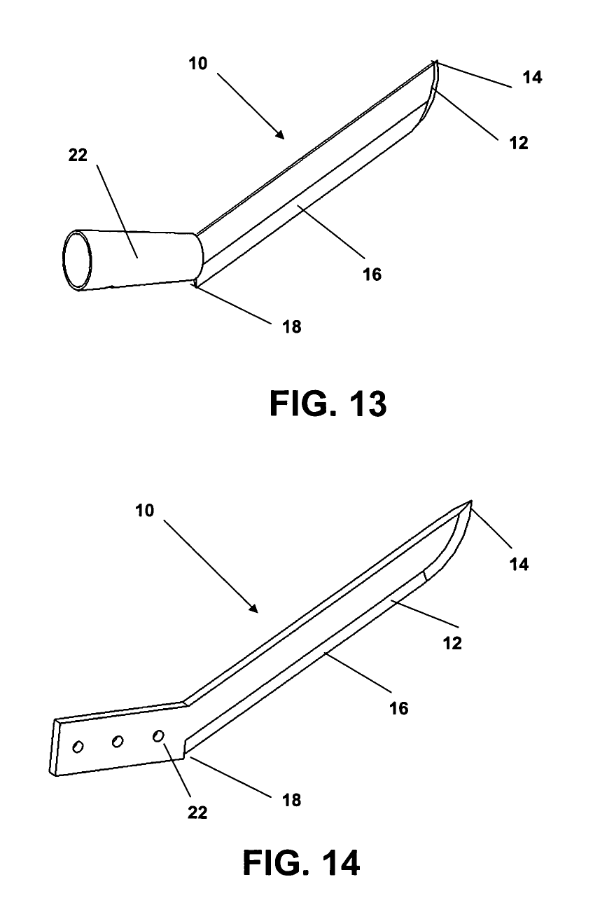

FIG. 13 and 14 are perspective views of another embodiment of the knife.

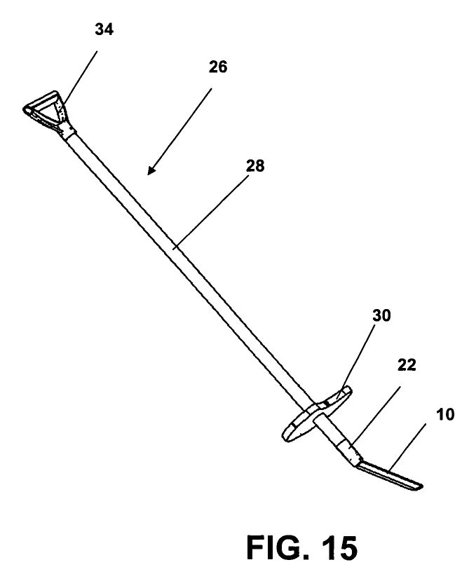

FIG. 15 is a perspective view of the edger with the knife and handle attached to the top of the wooden handle.

### DETAILED DESCRIPTION OF PREFERRED EMBODIMENTS

In the claims, the word “comprising” is used in its inclusive sense and does not exclude other elements being present. The indefinite article “a” before a claim feature does not exclude more than one of the feature being present.

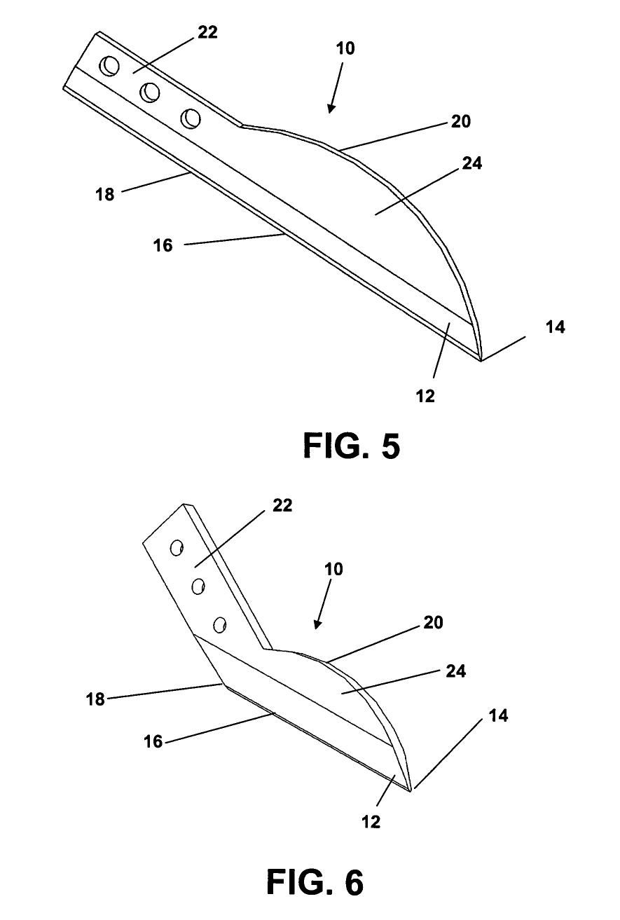

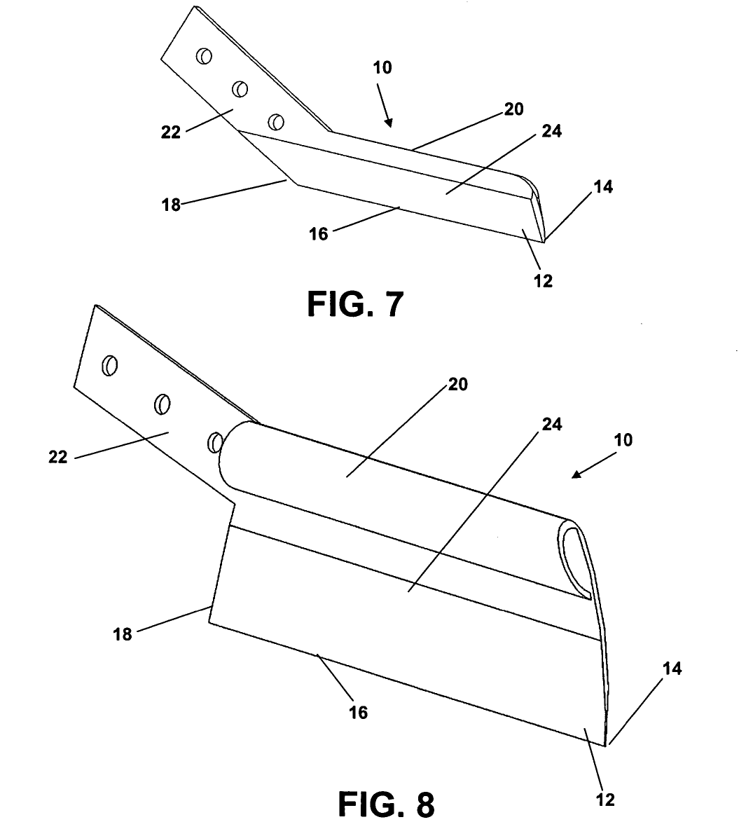

A typical knife 10 is shown in FIG. 2. The knife 10 has a tip 12 having a point 14, an edge 16, a heel 18, a spine 20, and a tang 22. Typically, a handle or grips known as scales (not shown) are attached to the tang 22 the flat portion of the knife 10 between the edge and the spine may be referred to as the blade 24. When a typical knife is adapted for use in the edger of the present invention, the knife 10 may take on various shapes, as shown in FIGS. 3 to 8, 13 and 14. For example, the knife 10 may have a curved edge 16 and a straight spine 20, as in FIG. 3 and FIG. 4. Alternatively, the knife 10 may have a straight edge 16 and a curved spine 20, as in FIG. 5 and FIG. 6. Again, the knife 10 may have a straight edge 16 and a straight spine 20 as in FIGS. 7, 13 and 14. Also, the knife 10 may be shaped similarly to a cleaver, as shown in FIG. 8, with the spine having a semi-circular shape. A knife like that shown in FIG. 8 may be formed from a rectangular piece of sheet metal folded over along one of the longer sides and sharpened on the opposite side to form the edge of the knife 10. The edge 16 of the knife 10 may also be serrated (not shown) to enhance the cutting effect.

The knife 10 may have any suitable shape for cutting through sod. For example, the knife 10 may be sharpened on one or both sides of the edge 16. In cross section, the knife 10 may have a substantially triangular shape, or else be rectangular ending in a wedge shape, or may have some other shape in cross section suitable for cutting through sod. The spine 20 of the knife 10 may be thickened to provide stiffness to the knife 10. It should be understood that regardless of the shape of the knife 10 in cross section, the blade 24 of the knife 10 has an even width and flatness from the tip 12 to the heel 18. In this way, when the knife 10 enters the ground, all portions of the blade 24 within the ground contact the ground surface evenly and in a relatively straight fashion. The knife 10 has a penetrating action as it is drawn through the sod, rather than tending to cause the sod to be overturned or otherwise disturbed, as is the case with edgers having scoops, protrusions off the cutting edge, or a curved blade in cross section.

An edger 26 in one embodiment of the invention is shown in FIG. 9. The edger 26 consists of a knife 10 and pole 28. The tang 22 of the knife 10 may be attached to the pole 28 in any suitable fashion, such as with fasteners 22, as shown in FIG. 9. When the knife 10 is attached to the pole 28 in this fashion, the tang 22 of the knife 10 will have holes for receiving fasteners, as shown in FIGS. 4 through 8. Alternatively, the tang 22 of the knife 10 may have a threaded end, as shown in FIG. 3, for threading on to the end of the pole, as shown in FIG. 10. The tang 22 of knife 10 may also have a taper on the inside as shown in FIG. 13 and the pole 28 will have a taper on the outside that will fit into the taper of tang 22 of the knife 10 as shown in FIG. 15. The pole 28 may also have a handle 34 as shown in FIG. 15. The pole 28 may be made out of any suitable material, but typically is made out of wood or metal.

The edger 26 preferably has a foot rest 30 attached to the pole 28 above the knife 10. A typical foot rest 30 is shown in FIG. 11. The foot rest 30 may be any shape suitable for placing a foot on either side of the pole, or at the center of the pole. In this way, the edger may be used by right-or left-handed people in either direction of cutting (pushing or pulling). The foot rest 30 preferably has a hole and is slid over an end of the pole 28 and fixed in place with one or more screws.

The sharpness, length and shape of the knife 10 enables a user of the edger 26 to cut through sod easily. The cut made is very sharp and well defined. Because the knife 10 is narrow and long instead of rounded and wide the cutting motion can be made continuous for a substantial distance before the knife 10 has to be moved from the ground. Cuts of a length of more than a meter can be done at one time. The narrow shape of the knife 10 also means that the direction of the cut can be easily changed allowing for many shapes to the edge of the lawn. More fancy designs can then be easily achieved with the new edger 26.

The edge 16 of the knife 10 may also be slightly angled with respect to the pole 28 to provide an easy angle of attack to start the cutting, as shown in FIGS. 10 and 15, or the edge 16 of the knife 10 may be substantially in line with the pole, as shown in FIG. 9. Examples of an edge 16 of a knife 10 that would be angled with respect to the pole once attached can be seen in FIGS. 3, 4, 6, 7, 8, 13 and 14. An example of an edge 16 of a knife 10 that would be substantially in line with the pole can be seen in FIG. 5. Because the edge 16 may be curved, the edge 16 may be considered to be slightly angled with respect to the pole 28 when a straight line 25 drawn between the heel 18 and the tip 12 forms an angle greater than 180 degrees with the tang 22 of the knife 10. Such a line 25, as shown in FIG. 4, compensates for the curve in the edge 16 of the knife to give a more accurate indication as to the angle of the edge 16 of the knife 10 with respect to the pole 28.

A guard 32 for the knife 10 can also be provided to increase safety and avoid accidents that may occur when the edger 26 is not in use, as shown in FIG. 12. The guard 32 is preferably attached to the pole 28 so that the guard 32 does not get misplaced. However, the guard 32 may be otherwise attached or clipped onto the edger 26 and removed from the knife 10 when the edger 26 is in use. Alternatively, the guard 32 may be attached so as to make the guard 32 move out of the way of the knife 10 when pressure is applied to the foot rest 30. The guard 32 then returns to the safety position after the foot is removed. Other mechanisms for automatically safeguarding the knife 10 can also be incorporated in the design.

While the preferred embodiments of the present invention have been shown and described herein, it will be obvious that such embodiments are provided by way of example only. Numerous variations, changes and substitutions will occur to those of skill in the art without departing from invention herein. Accordingly, it is intended that the invention be limited only by the spirit and of the appended claims. Immaterial modifications may be made to the embodiments of the invention described here without departing from the invention.

What is claimed is:

1. An apparatus, comprising,
a knife attached to a pole at an end of the pole for edging a lawn.

2. The apparatus of claim 1, further comprising a foot rest attached to the pole above the knife.

3. The apparatus of claim 1, further comprising a movable guard attached to the apparatus for covering the knife when the apparatus is idle.

4. The apparatus of claim 1, in which the knife further comprises a tip having a point, a heel opposite the tip, an edge extending between the tip and the heel, a spine extending between the tip and the heel opposite the edge, and a tang extending beyond the heel for attaching the knife to the pole.

5. The apparatus of claim 4, in which the tang further comprises a threaded portion for attaching to a threaded end of the pole.

6. The apparatus of claim 4, in which the edge of the knife is curved.

7. The apparatus of claim 4, in which the spine of the knife is curved.

8. The apparatus of claim 4, in which the spine of the knife is semi-circular in cross-section.

9. The apparatus of claim 4, in which the tang forms an angle of greater than 180 degrees with a straight line connecting the heel to the tip.
